(19) United States
(12) Patent Application Publication
(10) Pub. No.: US 2023/0032221 A1
(43) Pub. Date: Feb. 2, 2023

(54) Collaborative Streamlined Employee Outfitting

(71) Applicant: Worksteer LLC, Salt Lake City, UT (US)

(72) Inventor: Joe Visser, Salt Lake City, UT (US)

(21) Appl. No.: 17/392,233

(22) Filed: Aug. 2, 2021

(51) Int. Cl. G06Q 10/08; G06Q 10/10; G06Q 10/06; G06Q 30/06

(52) U.S. Cl. CPC G06Q 10/0875; G06Q 10/105; G06Q 10/06315; G06Q 30/0633; G06Q 30/0185

(57) ABSTRACT

A method for outfitting a worker/employee comprises identifying a job role associated with the worker, identifying one or more required gear items for the job role, presenting to the worker an interface for selecting products that satisfy the one or more required gear items, receiving from the worker a selection of one or more products that satisfy the one or more gear items, and purchasing the selected products from a third party.

### BACKGROUND OF THE INVENTION

The costs of hiring a new or temporary employee (or contractor, worker, etc.) are significant. Although in theory all costs associated with a new hire can be assigned a dollar or financial value, these costs are manifested in numerous ways: hard costs, human resource tune, work interruption, employee satisfaction, workplace safety, work interruption, attrition risk, workplace continuity, and delay. Many of the risks associated with a new hire can be mitigated by making sure the new hire is properly outfitted in a timely manner. Outfitting may comprise personal protective equipment (“PPE”), clothing, gear, tools, and any supplies that may be necessary or desirable for a worker to properly perform job functions, to fit into an existing workplace or project, and/or to fit in with existing workers.

Several circumstances may hinder timely and effective outfitting, e.g., location of the new worker, location of the new worker's worksite, sizing PPE and other gear for the new worker, the new worker's personal preferences, paving for gear, reimbursing the new worker and/or employment agency for gear, timing/delivery of gear, local inventory/availability of gear, and failure of a new worker to purchase the correct gear.

What is needed is an improved system and method for outfitting new workers (or existing workers).

### BRIEF SUMMARY OF THE INVENTION

A method for an outfitting server to receive information for a job role may comprise presenting a job role interface for creating new job roles, selecting existing job roles, editing job roles, and/or taking any other actions relative to defining or providing details for a job role; receiving job role information and/or details; presenting an interface for entering and/or selecting gear associated with a specific job role; and receiving the entered/selected gear specifications and/or details.

A method for an outfitting server to receive gear selections from a worker/user may comprise receiving authentication credentials to identify a worker; presenting a gear selection interface for the worker/user to select, order, and/or be apprised of gear requirements (or suggestions or options) for a job role with which the worker is or may be associated; receiving some or all gear selections; and/or ordering or purchasing the selected gear.

### BRIEF DESCRIPTION OF THE DRAWINGS

FIG. 1 shows an exemplary conceptual view of a network/communication scheme for an outfitting server, worker device, and employer device.

FIG. 2 shows a detailed view of an exemplary outfitting server.

FIG. 3 shows a detailed view of an exemplary job roles module.

FIG. 4 shows details for gear elements.

FIG. 5 shows an exemplary worker module for storing and managing information for individual workers.

FIG. 6 shows an exemplary worker-job-role-association module.

FIG. 7 shows an exemplary portal for a worker interface.

FIG. 8 shows an exemplary worker-gear interface.

FIG. 9a shows sourcing information for product options.

FIG. 9b shows sourcing information for product options.

FIG. 10 shows an exemplary complete-order interface.

FIG. 11 shows a flowchart for an exemplary method.

FIG. 12 shows a flowchart for an exemplary method.

### DETAILED DESCRIPTION OF THE INVENTION

A system and method are disclosed for collaborative streamlined outfitting if employees, personnel, or staff

Table of Reference Numbers from Drawings:

The following table is for convenience only, and should not be construed to supersede any potentially inconsistent disclosure herein.

| Reference | |
|---|---|
| Number | Description |
| 100 | outfitting server |
| 110 | job roles module |
| 120a-n | job role |
| 129 | gear column |
| 130 | gear element details |
| 131a-n | gear elements |
| 160 | worker module |
| 161a-n | workers in worker module |
| 170 | worker-job-role-association module |
| 171a-n | worker-job-role associations |
| 180 | communication channel |
| 185 | communication channel |
| 190 | network |
| 200 | employer device |
| 300 | employee device |
| 400 | worker interface portal |
| 410 | pending/active job roles interface |
| 420 | interface element for outfitting/gear |
| 500 | worker gear interface |
| 510a-n | gear selection interfaces |
| 520 | scroll arrow |
| 1100 | flowchart of exemplary method |
| 1110 | step for method in flowchart 1100 |
| 1120 | step for method in flowchart 1100 |
| 1130 | step for method in flowchart 1100 |
| 1140 | step for method in flowchart 1100 |
| 1200 | flowchart of exemplary method |
| 1210 | step for method in flowchart 1200 |
| 1220 | step for method in flowchart 1200 |
| 1230 | step for method in flowchart 1200 |
| 1240 | step for method in flowchart 1200 |

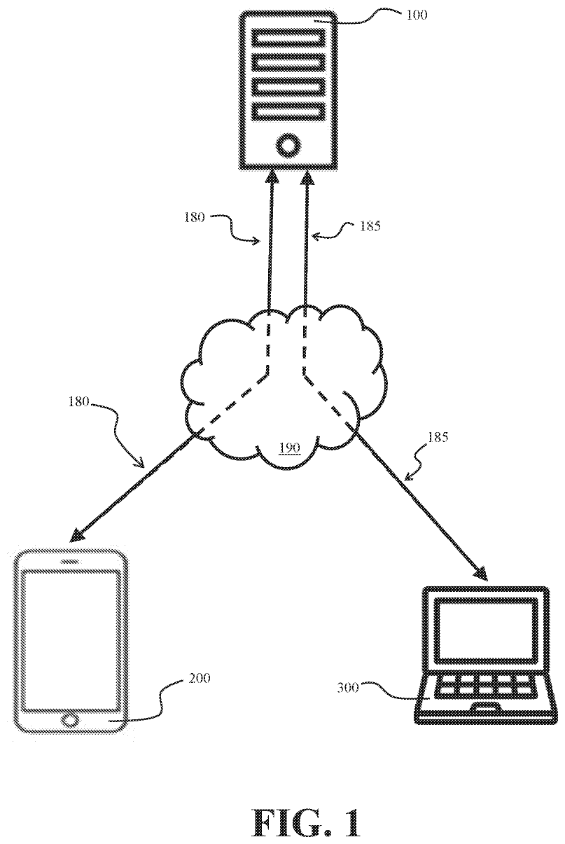

As shown in FIG. 1, worker outfitting system (“WOS”) may comprise an outfitting server 100 configured to communicate over a network 190 at least with an employer device 300 and a worker device 200. Outfitting server 100 may be any server technology/solution known in the art, including but not limited a server housed on one machine, a cloud server, a server distributed over multiple physical machines, a virtual server, and/or a combination of these or any other server technologies known in the art. Employer device 300 and worker device 200 may be any electronic computing devices known in the art, including but not limited to smartphones, smartwatches, laptops, tablets, and desktops.

Network 190 may be any communication network, including but not limited to the Internet. Communication channel 180 may be any communication channel between worker device 200 and outfitting server 100. Communication channel 185 may be any communication channel between employer device 300 and outfitting server 100.

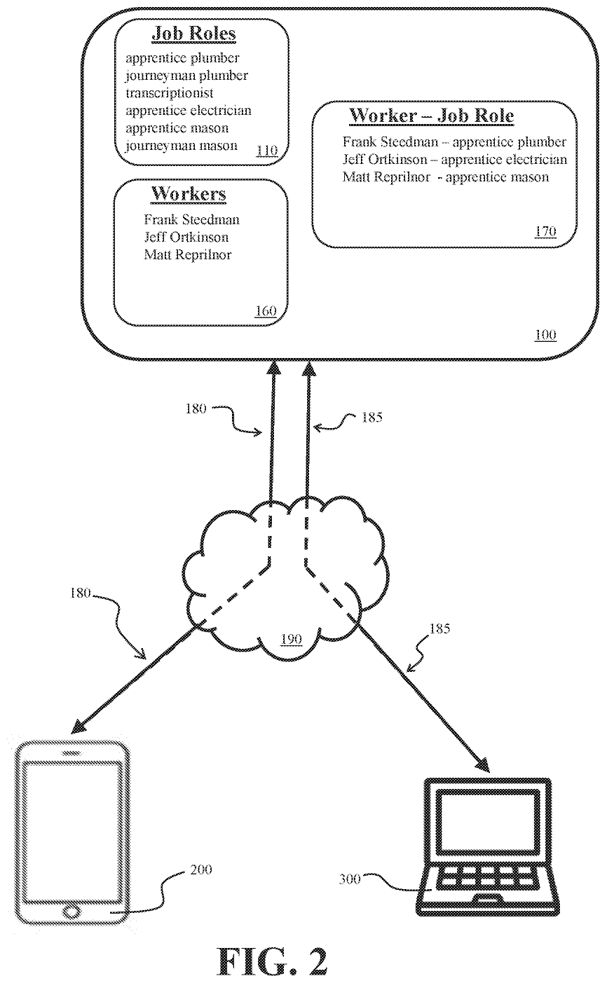

As shown in FIG. 2, outfitting server 100 may comprise a job role repository module 110, which may comprise one or more set of job roles and associated outfitting characteristics, parameters, and restrictions. Outfitting server 100 may additionally comprise (i) a worker module 160 for storing information about one or more workers, and (ii) a worker-job-role-association module for storing associations between workers in worker module 160 and job roles in job role repository module 110.

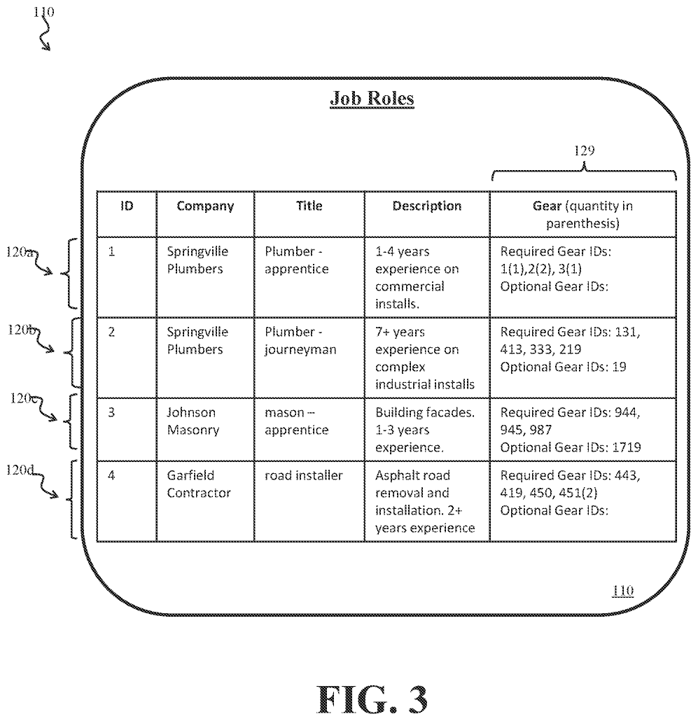

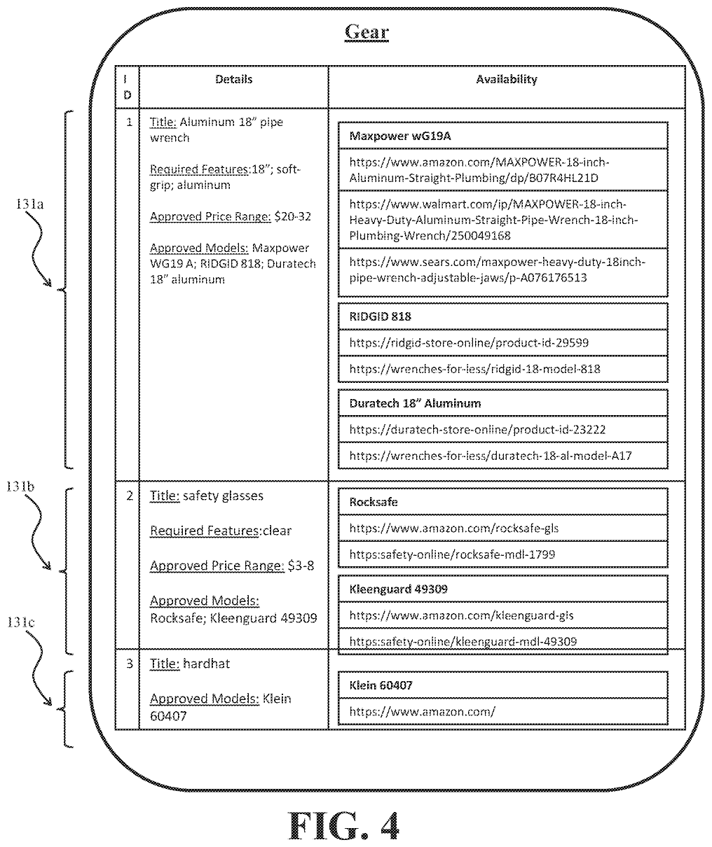

FIG. 3 shows a detailed view of an exemplary job roles module 110. In one embodiment, a job role may comprise some or all of the following characteristics: a unique job role identifier, company name or identifier, a title, a description, required gear, and optional gear. For example, as shown in FIG. 3 job role 120 may have a job role ID of “1,” a company name of “Springville Plumbers,” a title of “plumber-apprentice,” and a description of “1-4 years experience on commercial installs.” The “Gear” column 129 may comprise references to gear identifiers that each identify a specific gear element or set of elements. The details for each referenced gear element are shown in FIG. 4.

Required gear may comprise a set of required gear items. As used herein, “gear” may generally refer to PPE, equipment, tools, clothing, supplies, or any other items that an employer (or company or other user). For example, as shown for the Springville Plumbers apprentice plumber job role 120a, required gear may include two pairs of safety glasses, a hardhat, ear/hearing protection, steel-toe footwear, a cold-weather jacket, gloves, an aluminum 18-inch pipe wrench, multi-bit screwdriver, 2⅛″ pipe cutter. For the sake of simplicity, FIGS. 3 and 4 show only the 18-inch pipe wrench, safety glasses, and hardhat.

The optional gear for a job role may be a set of gear similar to the set of gear for the required gear.

Each element in the set of required gear may be referred to as a gear element. As shown in FIG. 4, a gear element may comprise a title, required features, optional features, acceptable price range, and/or approved/acceptable models. For example, gear element 131a may have a title of “Aluminum 18” pipe wrench,” required features of “18”, soft-grip, and aluminum,” an approved price range of $20-32, and approved/acceptable models may include Maxpower WG19 A, RIDGID 818, and Duratech 18″ aluminum. Additionally, the list of approved/acceptable models may include one or more references to brick-and-mortar or online stores where the gear element may be purchased, and/or one or more links to online stores for purchasing the gear element.

For example, as shown in FIG. 4, the Maxpower WG19A may be available from Amazon.com (https://www.amazon.com/MAXPOWER-18-inch-Aluminum-Straight-Plumbing/dp/B07R4HL21D), Walmart.corn (https://www.walmart.com/ip/MAXPOWER-18-inch-Heavy-Duty-Aluminum-Straight-Pipe-Wrench-18-inch-Plumbing-Wrench/250049168), Walmart in store, and Sears.com (https://www.sears.com/maxpower-heavy-duty-18 inch-pipe-wrench-adjustable-jaws/p-A076176513).

Gear elements 131b and 131c show additional gear elements required for job role 120a (job role ID “1”) in FIG. 3.

In one embodiment, an employer or other actor may add information to the Job Roles module through any of the many ways known in the art, e.g., through a web browser interface, app, client software, etc. In this manner, an employer may use employer device 300 to populate job module 110.

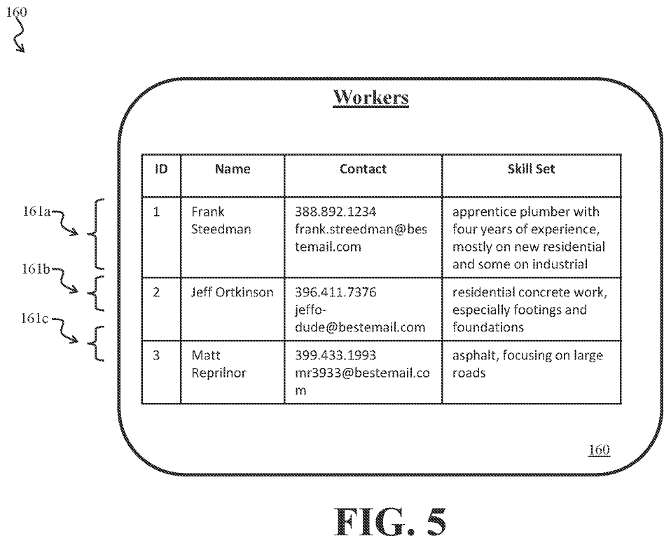

FIG. 5 shows an exemplary worker module 160 for storing and managing information for individual workers. The information stored for each worker may comprise one or more of a worker identifier, name, email address, phone number, skill set, and set of job role assignments. For example, an exemplary worker 161a in worker 160 module may have a worker ID of “1,” the name “Frank Streedman, an email address of “frank.streedman@bestemail.com,” a phone number of “388.892.1234,” and a skill set of “apprentice plumber with four years of experience, mostly on new residential and some on industrial” Workers 161b and 161c are additional workers.

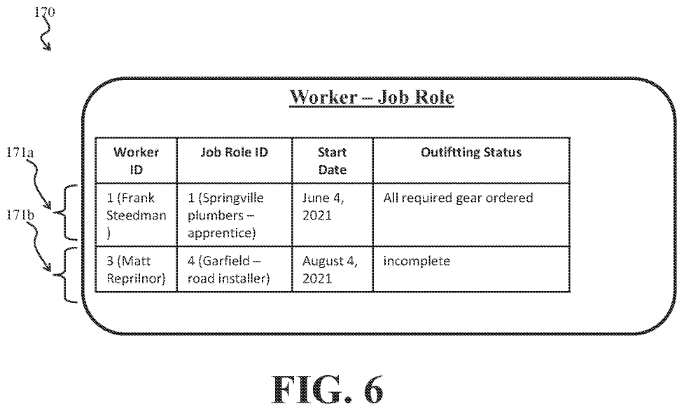

FIG. 6 shows an exemplary worker-job-role-association module 170, which may store any information relevant to association of a worker to a job role. Exemplary association 171a shows that worker Frank Steedman has been assigned to the Springville plumbers apprentice role with a start date of Jun. 4, 2021, and that of the required gear for Frank Steedman for this job role has been ordered. Association 171b is an additional exemplary worker-job-role association.

Worker Interface

An interface presented on worker device 200 may allow a worker to use a computing device (e.g., smartphone, laptop, desktop, tablet, etc.) to access information about an assigned job role. This interface may be referred to as the worker interface. The worker may access the worker interface by accessing an electronic resource (e.g., a URL) and providing credentials or otherwise identifying himself/herself. The worker interface may present to the worker details about an assigned job role, including but not limited to required gear and optional gear for the assigned job role.

In one embodiment, the worker interface may present required gear elements to the worker. Through the interface, for each required gear element, the worker may indicate that he/she has purchased the gear element and that the gear element is in the worker's possession, or that the worker has purchased or ordered the gear element and will shortly receive the gear element, or that the worker already has the gear element and a purchase is therefore unnecessary, or that the gear element is unavailable and the worker requests approval for a substitute (possibly, identifying/suggesting a specific substitute) and/or an amended approved price range.

In an alternate embodiment, the worker interface may present to the worker options for required gear and optional gear for the assigned job role. Although presented gear elements may be sourced from different stores (online, brick-and-mortar, or otherwise), they may all be presented to the worker through the same worker interface, and may allow the worker to select gear elements through the worker interface.

Once the worker has selected gear items through the worker interface, the worker interface e.g., the outfitting server) may place orders for the selected items with the various online stores or other sources.

For example; as shown in FIG. 6, a worker named Frank Streedman may be assigned to the apprentice plumber job role for the company Springville Plumbers. When Frank Steedman logs into or otherwise the worker interface, the worker interface may present the Worker Gear Interface. The Worker Gear Interface may present options for required and optional gear, as well as interface elements for selection of the required and optional gear elements.

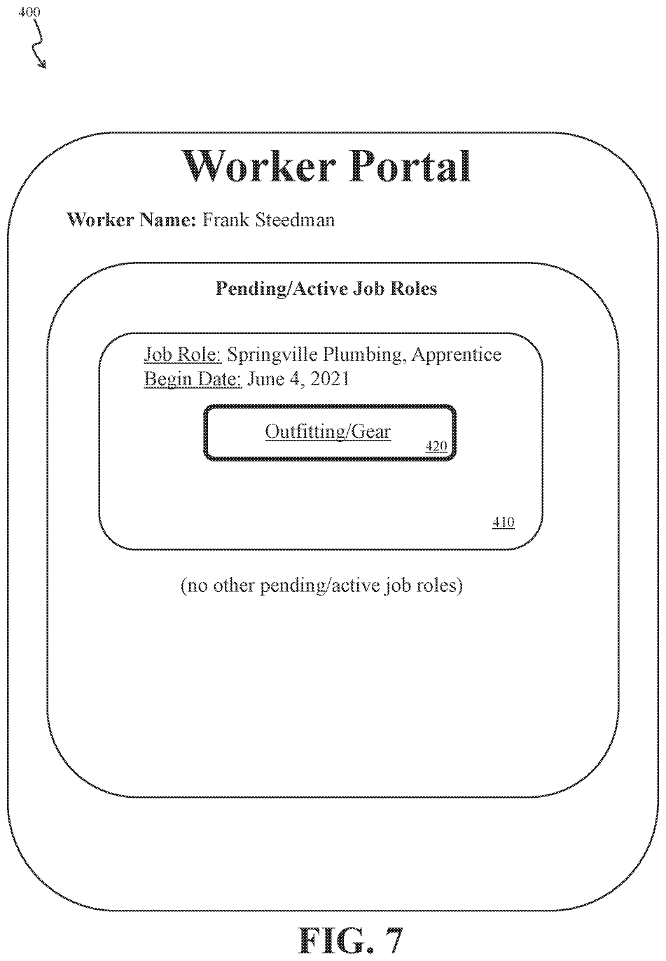

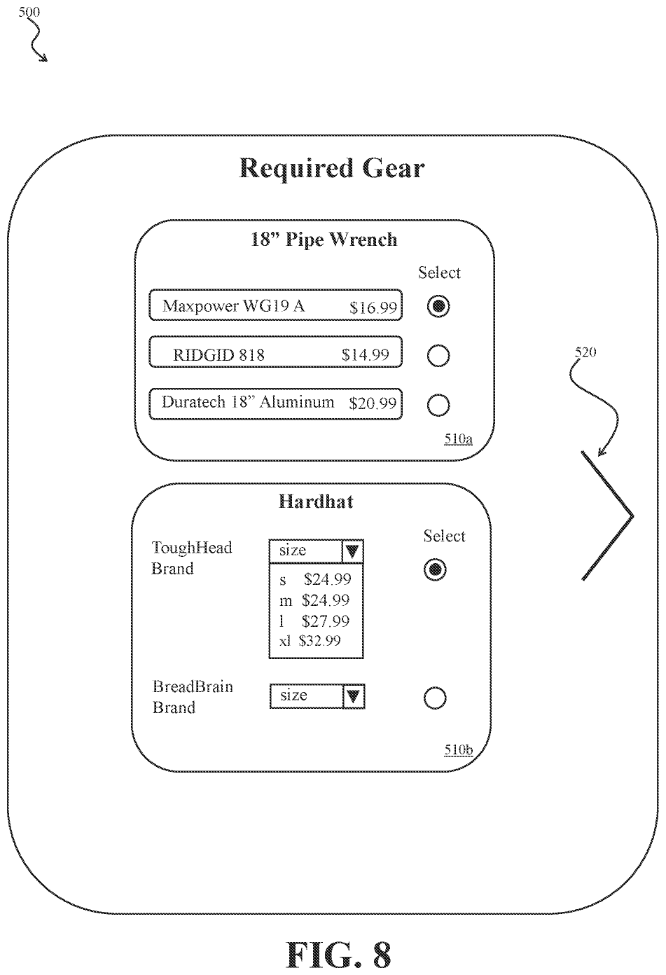

FIG. 7 shows an exemplary portal 400 for a worker interface. Portal 400 may be presented to a worker upon presentation of proper credentials or identification. Portal 400 may indicate that this is the worker interface for Frank Steedman, and that Frank Steedman has one pending/active job role 410, for Springville Plumbing—apprentice, with a begin date of Jun. 4, 2021. Interface element 420 may be selected to present to the user an interface for viewing, selecting, ordering, and/or editing gear associated with the job role. For example, when interface element 420 is selected, Worker Gear Interface 500 (as shown in FIG. 8) may be presented.

For example, as shown in FIG. 8, a Worker Gear Interface 500 may comprise gear selection interfaces 510a-n for selecting elements of required gear: an 18-inch pipe wrench (gear selection interface 510a) and a hardhat (gear selection interface 510b). Scroll arrow 520 may indicate that additional gear selection interfaces are available. As shown in FIG. 8, Worker Gear Interface 500 may provide no information about sourcing for two elements of required gear (gear selection interfaces 510a, 510b), but instead may provide only the information that is necessary to make gear selections. To a worker interacting with Worker Gear Interface 500, it may appear that the gear is coming from the administrator of the Worker Gear Interface. This will often not, however, be the case.

As a note, Worker Gear Interface 500 may provide information about where the elements of required gear are being sourced, but such information may often be unnecessary and superfluous.

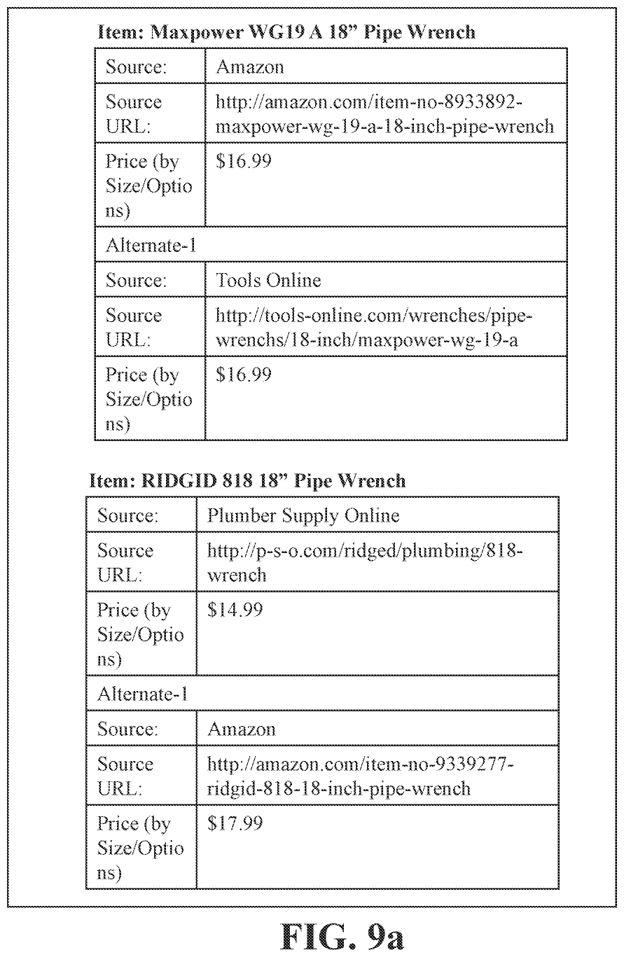

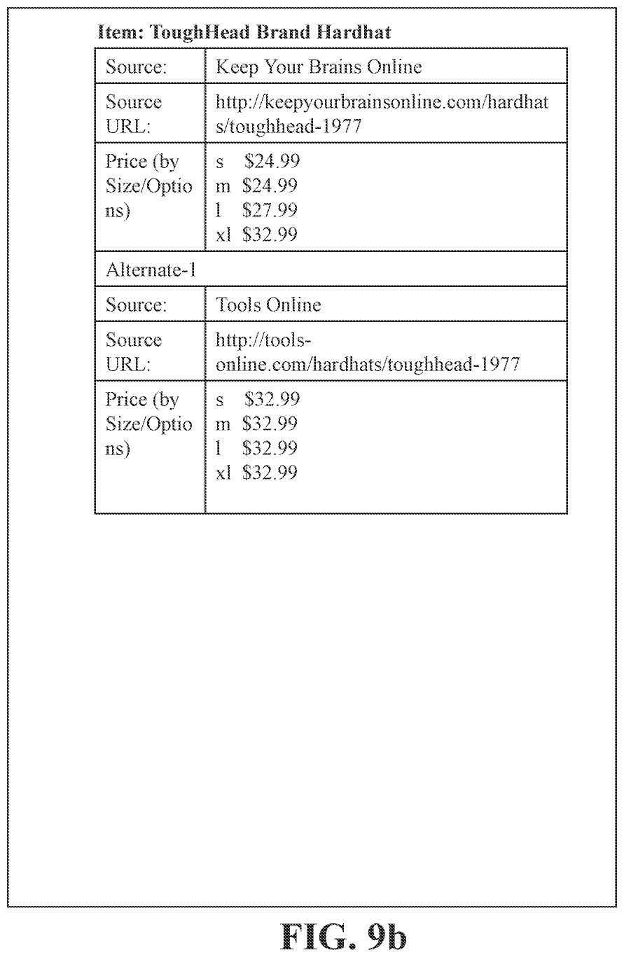

FIG. 9a shows the outfitting server's sourcing information for two of the wrench options shown in FIG. 8. As shown in FIG. 9a, the Maxpower wrench may be available from Amazon (and Tools Online as a backup/alternate) and the Ridgid wrench may be available from Plumber Supply Online and Amazon as a backup/alternate),

FIG. 9b shows the outfitting server's sourcing information for the hardhat in gear selection interface 510b in FIG. 8. As shown in FIG. 9h, the ToughHead Brand Hardhat may be available from Keep Your Brains Online (and Tools Online as a backup/alternate).

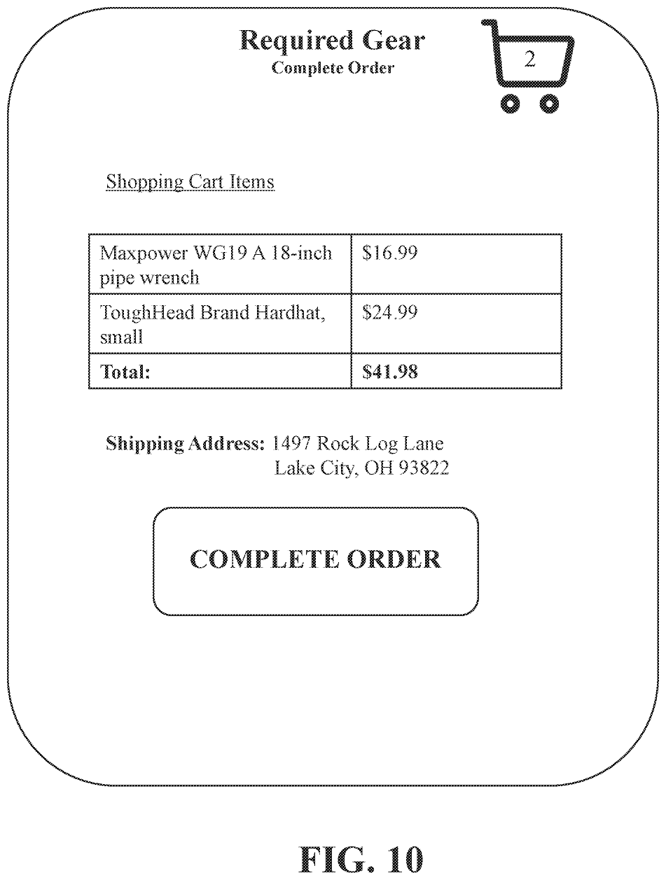

As shown in FIG. 10, when the worker has selected items from the options for the required gear elements, the Worker Gear Interface presents a Complete Order interface. Again, the true sourcing of the items may not be presented on the Complete Order interface. When the worker selects “Complete Order,” the gear system then places orders for the items from the associated sources. For the example in FIGS. 7-9, when the worker selects “Complete Order” in FIG. 9, the gear system then places an order with Amazon for the Maxpower wrench, and with Keep Your Brains Online for the hardhat.

Payment

In one embodiment, a worker may pay for a gear element and then submit a request for reimbursement. The reimbursement request may be provided through the WOS or another online system or otherwise.

In another embodiment, the worker may be provided with a voucher to a specific retailer, which may have brick-and-mortar and/or online locations. For example, the worker may be provided with a voucher to a retailer from which the worker can purchase some or all of the gear elements in the set of required gear elements and/or optional gear elements. The voucher may be a card, code, or other evidence of and/or authentication for access to purchase gear, which may be charged to a company account or to the account of a third party involved in onboarding, and/or outfitting the worker.

In another embodiment, a worker may be provided a voucher, or other rights to purchase from a retailer on a company or third-party account, that is limited to one or more specific product(s). For example, the worker may be provided with a voucher (or code, credentials, or similar evidence of authorization to purchase) to an online retailer, best-online-gear-retailer.com.

For example, the required gear for a job role may include, as a required gear element, an 18″ aluminum pipe wrench. The gear element may have an approved price range of $20-$32, and may identify three approved models: Brand A pipe wrench, Brand B pipe wrench, and Brand C pipe wrench. The gear element may additionally provide a link for each of these three models: http://best-online-gear-retailer.com/item-34423-brand-a-pipe-wrench-18, http://best-online-gear-retailer.com/item-83392-brand-b-pipe-wrench-18, and http://best-online-gear-retailer.com/item-38988-brand-c-pipe-wrench-18.

The worker interface may present to a worker, as one of the required gear elements, an 18″ aluminum pipe wrench, and may additionally present the three URLs shown above. When the worker selects and follows one of the links, he/she may purchase one of the approved pipe wrenches from best-online-gear-retailer.com. If the worker has been provided a voucher for best-online-gear-retailer.com, he/she may use the voucher at best-online-gear-retailer.com. The voucher may be limited to use on specific items, e.g., the voucher may be valid for purchasing only one from approved items Brand A pipe wrench, Brand B pipe wrench, and Brand C pipe wrench.

A voucher for a particular retailer may be limited to specific items.

In another embodiment, a link to an online retailer may result in a pre-populated shopping cart as a starting point for a worker to purchase his/her gear elements.

In another embodiment, as shown in FIGS. 8-10, the employer or WOS may pay for the gear directly when employee makes selections and completes an order. For example, as shown in FIGS. 8-1.0, and as described above for FIGS. 8-10, the gear system places an order with Amazon for a Maxpower wrench, and with Keep-Your-Brains-Online for the hardhat, and directly pays Amazon and Keep-Your-Brains-Online in the process.

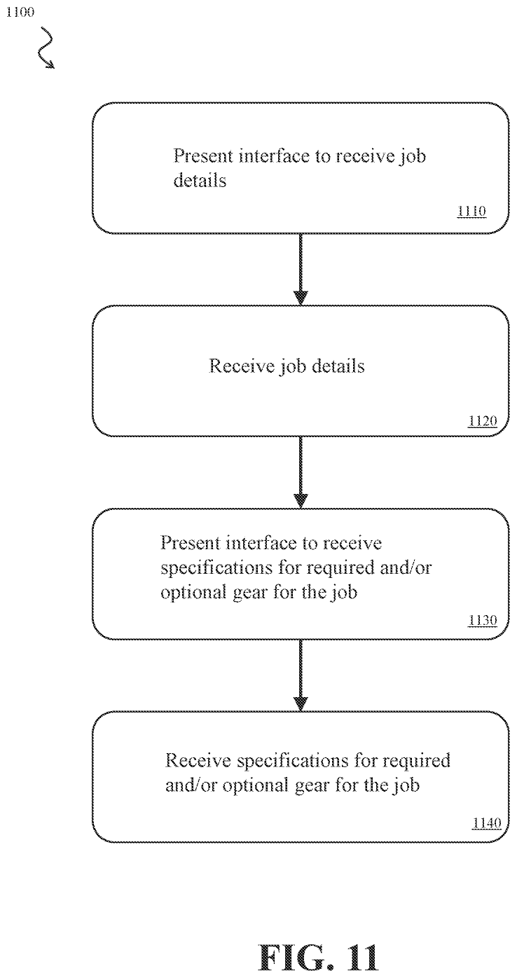

FIG. 11 shows a flowchart for an exemplary method for an outfitting server to receive information for an employer for a job role.

At step 1110, outfitting server may present (or provide the information for another interface application to present) an interface for selecting and/or entering job details. This interface may allow for creating new job roles, selecting existing job roles, editing job roles, and/or taking any other actions relative to defining or providing details for a job role.

At step 1120, the outfitting server may receive the entered/selected job role information and details.

At step 1130 the outfitting server may present an interface for entering and/or selecting gear associated with a specific job role. As described herein above; such information may include descriptions, options, whether a particular gear element is required, the quantity required, purchase options, and any other information or details relevant to a gear element that may be required for, optional for, or otherwise associated with a job role.

At step 1140, the outfitting server may receive the entered/selected gear specifications and/or details.

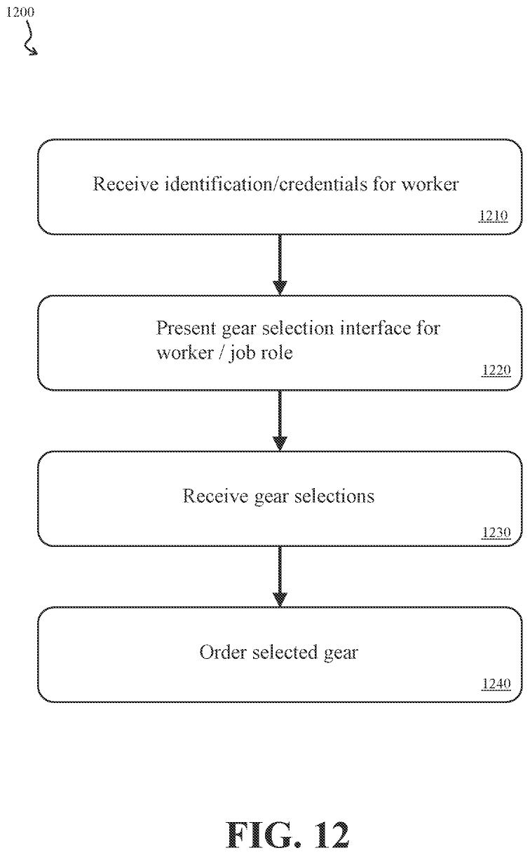

FIG. 12 shows a flowchart for an exemplary method for an outfitting server to receive gear selections from a worker/user.

At step 1210, the outfitting server may receive authentication credentials, identification information; or analogous information to identify a worker. In one embodiment, a worker may input or transmit such information from a computing device for the purpose of accessing the worker portal and/or gear selection portal.

At step 1220, outfitting server may present a gear selection interface for the worker/user to select, order, and/or be apprised of gear requirements (or suggestions or options) for a job role with which the worker is or may be associated. As described above, especially with reference to FIGS. 8-10, the presented gear selection interface may apprise a worker of gear requirements, options, or suggestions; identify approved or compliant products; identify sources (online, brick-and-mortar, or otherwise) for a user to purchase or obtain gear elements; provide an interface through which a worker/user may select one or more gear elements that may then be ordered by the employer or outfitting server; provide payment options for a worker when the worker will be paying for some or all of the gear (e.g., get billed, pay out of first paycheck); and/or any other functionality that may allow the worker to purchase/obtain approved and/or complaint gear for a particular job role.

In one embodiment, the gear selection interface may present one or more gear element options sourced from a third party, e.g., Amazon.com. The gear selection interface may or may not disclose that a gear will be ordered or provided from Amazon.com. Sourcing may be achieved manually, automatically, or in any other way. For example, in one embodiment a person may manually identify one or more sources for a specific gear element option, and may enter such options, e.g., a URL and/or or other information (e.g., pricing; description, images, reviews, etc.) into a database that may then be used for displaying some or all of such gear element option to a worker through the gear element interface. In another embodiment an automated search engine or crawler may identify sources for one or more gear element options and may either store information for identified sources in a database, or may search and fine some or all source information in a real-time manner for presentation to a worker through the gear element interface. Searching the Internet and/or online or other retail outlets for sources for gear element options may also comprise using APIs or other interfaces for communicating with online and/or brick-and-mortar storefronts.

In some embodiments, the gear element interface may present to a worker a set of gear elements, e.g., multiple gear elements that are the same brand, or that have a similar price point, or that are the best sellers, or that may have the best reviews, or that otherwise may be grouped to facilitate expediency in order gear elements. For example, if a worker is required to order a hardhat, gloves, and reflective pants, the gear element interface may present an option to order all three gear elements at once.

At step 1230, outfitting server 1230 may receive some or all of the selections or input from step 1220.

At step 1240, outfitting server may order selected gear, take other steps to effect or memorialize the worker's selections, update its records regarding the status of gear requirements for a particular worker for a particular job role, or to take any other necessary that may be necessary or appropriate in response to information and/or selections received from the worker/user.

Although the disclosure herein is directed toward outfitting new workers, the inventions herein may also be effectively applied to outfitting existing workers who may need new or replacement gear, or who may be switching jobs, or moving to a different worksite, or for any other reason that it may be beneficial or necessary to outfit, re-outfit, or provide supplementary outfitting to a worker.

What is claimed is:

1. A method for an outfitting server to outfit a worker, comprising:
identifying a job role associated with the worker;
identifying a gear element specification associated with the job role, wherein the gear element specification comprises one or more specifications for a personal gear element that is necessary or optional for the worker to perform the worker's job role;
providing, to an electronic device of the worker, a satisfactory option that satisfies the gear element specification, wherein the satisfactory option is available only from a third party;
receiving, from the worker's electronic device, a selection of a selected satisfactory option; and
purchasing, for a purchase price, the satisfactory option from the third party.

2. The method of claim 1, wherein the gear element is a required gear element.

3. The method of claim 1, wherein the gear element is an optional gear element.

4. The method of claim 1, further comprising:
identifying a second gear element specification associated with the job role;
providing, to the worker's electronic device, a second satisfactory option that satisfies the second gear element specification, wherein the second satisfactory option is available only from a third party;
receiving, from the worker's electronic device, a selection of a second selected satisfactory option; and
purchasing, for a purchase price, the second satisfactory option from the third party.

5. The method of claim 1, wherein providing a satisfactory option comprises disclosing the identity of the third party.

6. The method of claim 1, wherein providing a satisfactory option comprises not disclosing the identity of the third party.

7. The method of claim 1, further comprising receiving payment information from the worker's electronic device.

8. The method of claim 1, wherein the payment information comprises payment card information.

9. The method of claim 1, wherein the payment information voucher information.

10. The method of claim 1, further comprising recouping, from the worker, at least some of the purchase price.

11-17. (canceled)
